(19) United States
(12) Patent Application Publication
(10) Pub. No.: US 2005/0008212 A1
(43) Pub. Date: Jan. 13, 2005

(54) Spot finding algorithm using image recognition software

(76) Inventors: William R. Ewing, Encinitas, CA (US); Duane DeSieno, La Jolla, CA (US); Rhett L. Affleck, Poway, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/822,035

(22) Filed: Apr. 8, 2004

Related U.S. Application Data
(60) Provisional application No. 60/462,094, filed on Apr. 9, 2003.

(51) Int. Cl. G06K 9/00

(52) U.S. Cl. 382/133

(57) ABSTRACT

A plurality of samples are tested for their ability to enhance or inhibit a biological process in a multiplexed diffusive assay. The assay is imaged after the biological process has produced spots in a medium that indicate the tested enhancing or inhibiting ability of the samples. The image containing the resulting spots are evaluated to determine which samples caused the spots to form. The location of spots are identified by user selection or through a gradient triangulation technique that determines spot locations by analyzing the slope of pixel intensities in numerous subimages. The spots may also be analyzed by parametrically modeling the spots and comparing the spot characteristics in the image to a spot function, to determine the location of hit spots in the image. The hit spot locations, corresponding to the location of tested samples in the assay that enhanced or inhibited the biological process, are output to facilitate further analysis of the test samples.

### RELATED APPLICATION

This application claims priority under 35 U.S.C. §119(e) to U.S. Provisional Application No. 60/462,094, entitled SPOT FINDING ALGORITHM USING IMAGE RECOGNITION SOFTWARE, filed on Apr. 9, 2003, which is hereby incorporated by reference.

### BACKGROUND OF THE INVENTION

1. Field of the Invention

This invention relates to identifying features in a digital image, and in particular, to identifying spots in a digital image of a compound array such that absolute identification of specific compounds that exhibit biological activity is possible.

2. Description of the Related Art

High Throughput Screening (HTS) is the process by which a large number of substances can be simultaneously tested for biological reaction with an assay reagent. For example, one widely used HTS technique utilizes 96 well test plates that are approximately 8 cm×12 cm. Various compounds are placed in the wells and simultaneously tested for biological activity as an assay reagent is placed in each of the wells.

While the use of 96 well plates greatly improves the testing efficiency of large numbers of substances over previous techniques, there is a need for increased efficiency. As such, many firms in the industry are working towards decreasing the size of the wells on the plates so that an increased number of compounds may be simultaneously tested. For example, many assays now use 384 well plates. However, as the size of the wells further decreases, additional complexities are introduced to the HTS process. For example, the manufacture of the wells in the plates becomes increasingly complex and expensive. In addition, the accurate dispensing of compounds into smaller wells and other fluid handling steps becomes more difficult and error prone.

Other researchers have increased the number of compounds on a plate by eliminating the use of wells altogether. For example, U.S. Pat. No. 5,976,813, entitled “CONTINUOUS FORMAT HIGH THROUGHPUT SCREENING,” discloses an assay format in which multiple samples, or dots, of candidate materials (such as chemical compounds) are placed onto a supporting layer, preferably in dry form, and are then transferred into a porous assay matrix, such as a gel, a filter, a fibrous material, or the like, where an assay is performed. In the context of this type of assay, one such supporting layer carrying an array of assay materials, preferably dried, is referred to by the name “ChemCard,” which is proprietary to Discovery Partners International, Inc. Such usage in this disclosure is simply for purposes of convenience, and is neither an indication that ChemCard is considered generic or descriptive, nor an indication that the invention is limited to any particular type of supporting layer or any particular type of ChemCard that is available from Discovery Partners International, Inc.

Assays of this type, which occur in a porous matrix or other material in which reactants can diffuse, can sometimes produce initially ambiguous results which will require interpretation or translation to eliminate the ambiguity. Because the reactants are not held in discrete locations, e.g., a well, a positive result can be in the form of a “spot” that has diffused out to a diameter greater than that of the original dot on the ChemCard. The diameter of this spot can reach or encompass the locations of multiple dots.

During the course of some assays, the compound travels from the original ChemCard into one or more porous assay matrix layers, e.g., gel layers, or onto another surface, both of which are hereafter referred to as a “receiving layer.” Although the compounds generally keep their relative x, y centers, they may diffuse radially, even non-symmetrically, becoming more dilute. To evaluate the assay for reactive compounds, an image of the assay may be created and analyzed to determine which compounds reacted with the assay reagent. Therefore, the eventual spot created by the differential signal in the assay response to an “active” compound may be on an image derived from a medium that did not originally contain the compound dot, and thus, there can be a discrepancy between the relative position of the center of the spot and the relative position where the compound dot was originally placed on the ChemCard. Unlike assays performed in wells, there is not a visual outline to indicate where each compound is centered. If no errors were introduced in the x and y coordinates during the assay process, each compound responsible for a spot can be identified. However, as error can be introduced at each step of the assay process, definitively identifying the compound dot that produced each spot is increasingly difficult. For example, error may be introduced by the liquid handler that places the compound dots on the supporting layer. The diffusion of the compound between the supporting layer and a receiving layer may also introduce error. Other possible errors may come from distortions caused by the receiving layer flexibility and the nonlinear aspects of image collection. Each of these factors may contribute to the error that is equal to the relative distance between the center of an imaged spot and the center of the compound dot on the original supporting layer, sometimes referred to as dot-spot error (“DSE”). Generally, if the DSE is less than half of the distance between compound dots, then the spots may be readily correlated with their respective dots. However, if the DSE is greater than one half the distance between compound dots, ambiguity may exist in the determination of the spot producing compound dot. As such, a method is desired for accurately correlating the spots with their respective dot array locations, thus allowing the identification of the corresponding spot generating compounds.

### SUMMARY OF THE INVENTION

This invention includes methods and systems for identifying and analyzing features in an image, which may be, for example, from a biological assay. According to one embodiment, the invention comprises a method of identifying the location of a compound in an assay pattern created in a diffusive or free-form biological assay, comprising providing an image of the assay pattern, wherein the image has pixels that depict a spot, identifying the center of the spot by analyzing a plurality of pixels in the image, generating a model of a signal at the location of the spot, wherein the model of the signal is based on the diffusion of a reactive compound in a reagent containing layer, determining whether the spot is a signal by comparing the spot and the model, and for a spot identified as a signal, determining the sample compound location on the assay pattern that corresponds to the image location of the center of the spot.

According to another embodiment, the invention comprises a method of identifying the location of a signal in an image of a biological assay, comprising providing an image of the assay, wherein the image has a plurality of pixels depicting the signal, defining a subimage pixel area in the image, centering the subimage pixel area on a target pixel in the digital image, calculating a pixel intensity slope for the target pixel, wherein pixels contained within the subimage area are used to calculate the pixel intensity slope of the target pixel, storing the result of the calculating step, repeating the centering, calculating, and storing steps for a plurality of target pixels in the digital image, and combining the stored results to identify the location of the signal.

According to yet another embodiment, the invention comprises a method for identifying a hit spot in a free-form biological assay, where the hit spot is the result of an interaction between a sample compound and a reactive agent, comprising providing a digital image, wherein the image depicts a plurality of candidate spots which may include a hit spot, analyzing the image by image processing means to identify a first candidate spot, generating a spot function parametrically modeling the first candidate spot, and analyzing the spot function and the first candidate signal to identify a hit spot depicted in the digital image.

According to another embodiment of the invention, the invention comprises a system for identifying a signal location in a digital image of a biological assay, comprising a gradient triangulation subsystem with means for identifying the location of a candidate signal in the image, and a signal modeling subsystem with means for processing a set of pixels in the image proximate to the candidate signal location to determine if a signal exists at the candidate signal location.

According to another embodiment of the invention, the invention comprises a method of identifying a hit spot depicted in an image, comprising providing a digital image, wherein the image may depict hit spots, processing the image by image processing means to acquire a set of spots depicted in the image, generating parameters for each spot in the set, generating a spot function for each spot in the set, the spot function parametrically modeling each spot, and analyzing the spot function and the parameters to identify hit spots from the set of spots depicted in the image.

According to another embodiment of the invention, the invention comprises a method of correlating a hit spot depicted in an image with a corresponding sample compound location, comprising providing a digital image, wherein the digital image depicts alignment spots and may depict hit spots, identifying alignment spots contained in the image, registering the image by matching a plurality of alignment spots to a known alignment pattern, identifying a spot depicted in the image, generating a spot function, the spot function parametrically modeling the spot, comparing the spot function and the spot to determine if the spot is a hit spot, and correlating the location of the hit spot depicted in the image with a known sample compound pattern to identify a sample compound location corresponding to the location of the hit spot.

According to another embodiment of the invention, the invention comprises a method of correlating a signal in a representative digital image of a free-form biological assay to an associated sample compound location, comprising identifying a candidate signal location in the digital image, generating a function to model a signal formed in a free-form biological assay, generating parameters describing the digital image at the candidate signal location, generating a correlation value, the correlation value being a measure of fitness between the function and the digital image at the candidate signal location, analyzing the correlation value and the parameters to identify a signal location in the digital image, and correlating the signal location with a known pattern to identify a sample compound location.

According to another embodiment of the invention, the invention comprises a computer readable medium tangibly embodying a program of instructions executable by a computer to perform a method of identifying a location of a sample compound that generated a hit spot in a biological assay, the method comprising providing a digital image of the assay, wherein the image comprises pixels depicting a spot, analyzing the pixels in the digital image to identify the location of the spot, generating parameters describing the spot, generating a spot function, the spot function parametrically modeling the spot, generating a correlation value, the correlation value being a measure of fitness between the spot function and the spot, analyzing the parameters and the correlation value to determine if the spot is a hit spot, and correlating the location of the hit spot in the image with an assay pattern to identify a sample compound location.

According to another embodiment of the invention, the invention comprises a method for identifying features of an image, comprising providing a digital image comprising pixels, for a set of pixels in the image (a) assigning to a target pixel one or more values representative of one or more of intensity or color of the target pixel, (b) determining the one or more values for neighbor pixels around the target pixel, (c) if the value assigned to the target pixel is different from values of the neighbor pixels, determining a direction representative of maximum change or rate of change of the value from the target pixel into the neighbor pixels, and associating a vector with the target pixel indicative of the direction, (d) repeating steps (a)-(c) for each pixel in the set, and (e) identifying one or more features by identifying a pattern from said vectors.

According to yet another embodiment of the invention, the invention comprises a method of registering a digital image of a biological assay, comprising providing a digital image containing pixels, wherein the pixels depicts a plurality of spots, identifying one or more alignment spots depicted in the image, matching the one or more alignment spots to a known pattern of alignment spots, calculating a plurality of alignment factors for a plurality of locations in the image based on said matching, and registering the image using the alignment factors to match the spot locations to known locations using a sample compound pattern.

According to another embodiment of the invention, the invention comprises method of registering a digital image to identify a hit spot in an image with a corresponding sample compound location, comprising providing a digital image, wherein the digital image depicts a plurality of alignment spots and at least one pair of hit spots, identifying one or more alignment spots depicted in the image, registering the image by matching the one or more alignment spots to a known alignment pattern, identifying a probable pair of hit spots depicted in the image, calculating a plurality of alignment factors using the locations of the probable pair of hit spots and the alignment spots, and using known patterns of pairs of hit spots and the alignment patterns, registering the image using the calculated alignment factors to match the locations of the image to known locations in a sample compound pattern, and determining if an additional probable pair of hit spots is in the image, and if so, iteratively repeating said calculating step and said registering step using the additionally identified pair of hit spots.

According to yet another embodiment of the invention, the invention comprises A method of identifying a hit spot in an image, comprising providing a digital image, wherein the image may depict hit spots, processing the image by image processing means to acquire a set of spots depicted in the image, generating parameters for each spot in the set, generating a value for each spot in the set, wherein the value is a measure of whether the spot is a hit spot, generating a list of spots having a high value, and for the list of spots: (a) optimizing the parameters of a selected spot on the list, the selected spot having the highest value, (b) removing the selected spot from the list of spots, (c) removing information related to the selected spot from the image, (d) generating a new value for each spot remaining on the list, (e) repeating steps (a)-(d) until there are no remaining spots on the list, and analyzing a spot using its value to identify the spot as a hit a spot.

### BRIEF DESCRIPTION OF THE DRAWINGS

The above-mentioned and other features and advantages of the invention will become more fully apparent from the following detailed description, the appended claims, and in connection with the accompanying drawings in which:

FIG. 1 is a block diagram of a computer system.

FIG. 1A is a flow diagram of an assay analysis process.

FIG. 2 is a block diagram of a feature finding module that can be used to identify features in a digital representation of an assay.

FIG. 2A illustrates alignment references.

FIG. 3 is a flow diagram showing a process that uses gradient triangulation to identify features in digital data.

FIG. 4A illustrates the selection of a subimage in the gradient triangulation process.

FIG. 4B illustrates the selection of a subimage in the gradient triangulation process.

FIG. 5 illustrates vectors drawn from subimages shown on a curved surface of a feature.

FIG. 6 illustrates the vectors from FIG. 5 depicted on a two-dimensional image.

FIG. 7 illustrates the accumulation of numerous vectors in a two-dimensional image.

FIG. 8 is an exemplary image prepared using a plurality of symbols where the combined symbols in the image identify features.

FIG. 9 illustrates a basic Gaussian shape for a typical spot.

FIG. 10 illustrates a shape for a flattened Gaussian spot.

FIG. 11 is a flow diagram showing the spot modeling process for identifying spots.

### DETAILED DESCRIPTION OF CERTAIN INVENTIVE ASPECTS

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

A. Definitions

Digital representation (of an assay): A digital image of an assay, generated by, for example, a CCD camera, a scanner (e.g., scanning in a photograph, negative, or transparency of the assay), or a spectrophometric device.

Dot: A sample of a material used in an assay, and placed on a supporting layer, for example, a ChemCard.

Feature: A particular object represented by a set of pixels. For example, a feature may be a spot.

Gel image: A digital image of an assay, and another term used for a digital representation.

Hit Spot: A spot formed on or in the assay matrix that meets sufficient criteria to indicate that the compound that correlates to the spot did, in fact, react and induce a signal or cause a signal to be suppressed.

Signal: Indicia that indicates the presence of a reaction between a compound dot and a reagent. For example, a spot may be a signal.

Spot: A discernable change formed on or in the assay matrix that may be the result of a compound's reaction to an assay reagent. As criteria describing the spot is being evaluated, the spot may also be referred to as a candidate hit spot.

Spot Density Profile: The representation of the density of a spot in relation to its two-dimensional spatial coordinates.

Spot Intensity Profile: The representation of the intensity of a spot in relation to its two-dimensional spatial coordinates.

B. System

The systems and methods of this invention identify features in images, according to one embodiment. These methods are particularly useful for identifying a feature in an image of a biological assay and correlating the feature to the compound that produced the feature, according to one embodiment of the invention. A feature may be a spot created by the differential signal in the assay response to an reactive compound. Although the disclosed systems and methods are described in relation to biological assays, they are not limited to that application, but instead may be applied to a variety of feature finding image processing applications.

By identifying a spot and determining the location of the center of the spot, the location of the compound that created the spot, and corresponds to the center of the spot, may be identified, according to one embodiment. Modeling the spot's parameters can identify the presence of a “hit spot,” that is, a spot that meets sufficiency criteria to indicate that the compound which correlates to the spot did in fact induce a signal or cause a signal to be suppressed through its interactions with the bioreagents. Determining which spots are actually hit spots and identifying their corresponding compounds allows for further analysis of those compounds, if desired. Spots that have developed in a biological assay may be either lighter or darker or of a different color than the gel or substrate “background” as a result of the particular biological assay performed.

In continuous format high throughput assay screening, spots that develop result from freely diffusing compounds that interact with reagents that are either in a gel or on a surface, e.g., of a membrane. These active compounds either induce or suppress a signal due to their interaction with the bio-reagents present. A developed spot shape and its density profile created by these active compounds is, therefore, a combined effect of diffusion and chemical reaction(s) of the compound and reagents involved. The spot density profile in the biological assay corresponds to a spot intensity profile in an image representation of the assay, where the dynamic range of the detector may influence the spot intensity profile. The spot size may be influenced by a number of factors, such as diffusion rates and reaction rates. For example, there are many different types of assays and although the diffusion rates of the compounds may be similar, the diffusion rates of reagents can vary or be zero for immobilized reagents. The reaction rates between the compounds and the reagents will vary in type (binding, enzyme, cell assimilation, etc.) and rate. Thus, an effective spot finding method may advantageously address various spot sizes and spot intensity profiles. One common spot factor is that typically diffusion from the initial dry compound into the gel will be radially symmetric, thus creating circular spots. Therefore, a spot finding algorithm may advantageously use the fact that the signal typically consists of a radially symmetric concentration gradient.

Modeling the spots generates quantitative results for each spot. Currently, high throughput screening assays result in some quantifiable number of spots from which to cull the top performing compounds. Modeling the spots provides quantifiable compound comparisons that can be used to determine the top performing compounds. The methods described herein calculate the signal generated by the compound, according to one embodiment. The background signal level of the receiving layer may vary across the layer. According to one embodiment, only the signal generated by the compound is modeled, thus ignoring the local background signal level. Similarly, signals generated by neighboring compounds, dust or other anomalies may be ignored, according to one embodiment. According to another embodiment, the background signal level is calculated and accounted for in the calculation of the signal generated by the compound, for example, by subtracting the background signal level.

Analysis of a spot with a spot profile modeling function (hereinafter referred to as a “spot function”) may be used to determine if a spot is a hit spot, according to one embodiment. The spot function models a spot formed in the receiving layer, e.g., a gel, and may take into account the characteristics of the receiving layer. For example, the spot function can model the flatness of a spot caused by the physical limitation of the gel's thickness. Parameters of the spot are generated from the information contained in the gel image at the location of the spot, and a correlation value may be calculated. The basic meaning of the correlation value is the fraction, or percent, of the image variation that is explained by the spot function. Because modeling of the spot takes place across a large number of pixels, this statistic is relatively insensitive to noise. A spot with a correlation value above a threshold value or having parameters that meet certain criteria may be saved in a list and further processed by optimizing their parameters.

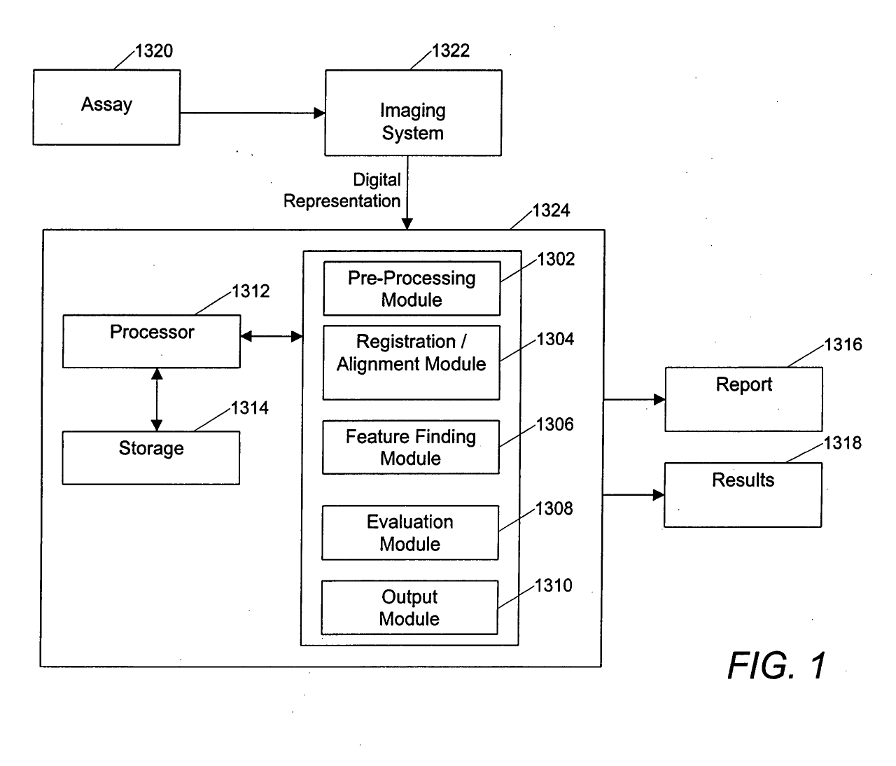

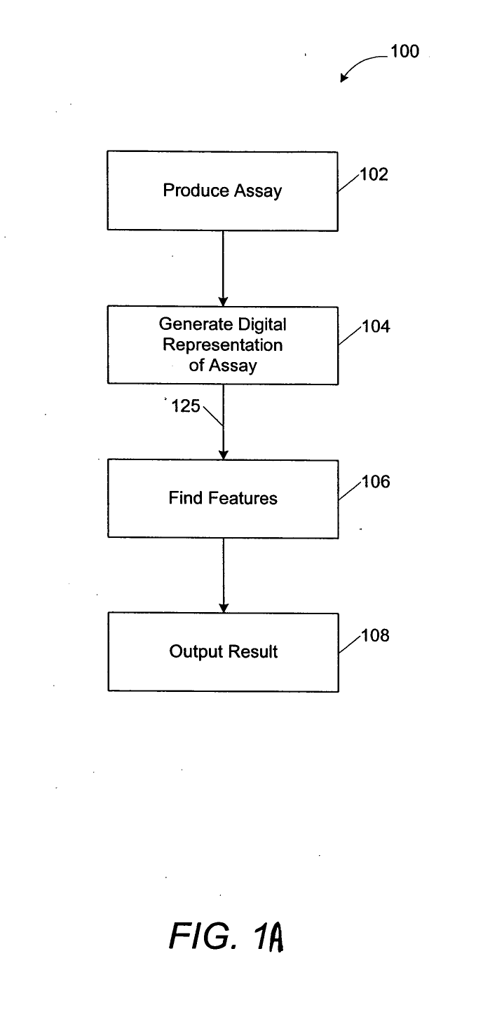

The methods and procedures described herein may be implemented in computer or a system that includes a computer. FIG. 1 shows a block diagram of a computer 1324 in communication with an imaging system 1322, according to one embodiment. The computer 1324 acquires and analyzes the digital representation, identifies a candidate spot and further analyzes the spot to determine if it is, in fact, a hit spot, according to one embodiment. The imaging system 1322 and the computer 1324 can be co-located or geographically separated. The imaging system 1322 receives a biological assay 1320, creates a digital image representation of the assay, and provides the digital representation to the computer 1324, according to one embodiment. The computer 1324 can also receive data related to the assay, for example, registration, pattern, and test compound information. The imaging system 1322 may generate the digital representation from the assay using an imaging device capable of producing a digital image, e.g., a digital camera, or indirectly. Alternatively, the imaging system 1322 may generate a non-digital image of the assay, e.g., a negative, slide, or photograph, and converting the non-digital image to a digital representation using a suitable digitizing device, e.g., a scanner or a digital imaging device, according to another embodiment. The imaging system 1322 communicates the digital representation to the computer 1324 by an electronic interface, e.g., a direct electronic connection between the imaging system 1322 and the computer 1324, by a network connection, or by a type of removable media, e.g., a 3.5″ floppy disk, compact disc, DVD, ZIP drive, magnetic tape, etc.

The computer 1324 may contain conventional computer electronics including a processor 1312 and memory or storage 1314, e.g., a hard disk, an optical disk and/or random access memory (RAM). Other electronics that are not shown in FIG. 1 may also be included in the computer 1324, including a communications bus, a power supply, data storage devices, and various interfaces and drive electronics. Although not shown in FIG. 1, it is contemplated that in some embodiments, the computer 1324 may include a video display (monitor), a keyboard, a mouse, loudspeakers or a microphone, a printer, devices allowing the use of removable media including, but not limited to, magnetic tapes and magnetic and optical disks, and interface devices that allow the computer 1324 to communicate with another computer, including but not limited to a computer network, an intranet, or a network, e.g., the Internet.

It is also contemplated the computer 1324 can be implemented with a wide range of computer platforms using conventional general purpose single chip or multichip microprocessors, digital signal processors, embedded microprocessors, microcontrollers and the like. A user can operate the computer 1324 independently, or as part of a computing system. The computer 1324 may include stand-alone computers as well as any data processor controlled device that allows access to a network, including video terminal devices, such as personal computers, workstations, servers, clients, mini-computers, main-frame computers, laptop computers, or a network of individual computers. In one embodiment, the computer 1324 may be a processor configured to perform specific tasks. The configuration of the computer 1324 may be based, for example, on Intel Corporation's family of microprocessors, such as the PENTIUM family and Microsoft Corporation's WINDOWS operating systems such as WINDOWS NT, WINDOWS 2000, or WINDOWS XP.

The software running on computer 1324 that implements the methods and procedures described herein can include one or more subsystems or modules. As can be appreciated by a skilled technologist, each of the modules can be implemented in hardware or software, and comprise various subroutines, procedures, definitional statements, and macros that perform certain tasks. The functionality described for each method and identification system may be implemented in software or hardware. In a software implementation, all the modules are typically separately compiled and linked into a single executable program. The processes performed by each of the modules may be arbitrarily redistributed to one of the other modules, combined together in a single module, or made available in, for example, a shareable dynamic link library. These modules may be configured to reside on the addressable storage medium and configured to execute on one or more processors. Thus, a module may include, by way of example, other subsystems, components, such as software components, object-oriented software components, class components and task components, processes, functions, attributes, procedures, subroutines, segments of program code, drivers, firmware, microcode, circuitry, data, databases, data structures, tables, arrays, and variables. It is also contemplated that the computer 1324 may be implemented with a wide range of operating systems such as Unix, Linux, Microsoft DOS, Macintosh OS, OS/2 and the like.

The illustrative embodiment of the computer 1324 shown in FIG. 1 includes a pre-processing module 1302 that can filter the received digital representation prior to further processing. The digital representation may be filtered to remove “noise” such as speckles, high frequency noise or low frequency noise that may have been introduced by any of the preceding steps including the imaging step. Filtering methods to remove high frequency or low frequency noise are well known in image processing, and many different methods may be used to achieve suitable results. For example, according to one embodiment in a filtering procedure that removes speckle, for each pixel, the mean and standard deviation of every other pixel along the perimeter of a 5×5 pixel area centered on a pixel are computed. If the center pixel varies by more than a threshold multiplied by the standard deviation, then it is replaced by the mean value. Then the slope of the 5×5 image pixel intensities is calculated and the center pixel is replaced by the mean value of pixels interpolated on a line across the calculated slope.

The computer 1324 also includes a registration module 1304 that aligns, or registers, the image to a known coordinate system, described in detail further below, according to one embodiment. The computer 1324 also includes a feature finding module 1306 that identifies features contained in the digital representation and assay data received by the computer 1324. The computer 1324 includes an evaluation module 1308 that facilitates user evaluation of the spots identified by the feature finding module 1306 and allows the user to make adjustments to the list, if desired. An output module 1310 is also included in the computer to generate a suitable data output, e.g., reports, based on the results of processing the digital representation, or an exemplary image. For example, a report 1316 may include the list of hit spots identified in the digital representation, or may include more detailed information related to the ranking of the features found in the digital representation. The results 1318 may include depicting the results of the analysis in an image which can be used for further review in conjunction with the report.

A section of an image may be specified to be used for identifying spots, or the entire image may be used. Specifying an area of the image may avoid the margins of an image where there are often ragged, high-contrast features that have the potential for being identified as spots. A candidate spot may be identified in several ways, including through an interactive selection process where a user analyzes the digital representation, or by an automated process that selects candidate spots from the digital representation or it may be identified by a combination of both techniques. Again, it should be emphasized that embodiments of the present invention are of general applicability in image analysis, and the references to gels throughout the disclosure are exemplary, not limiting.

FIG. 1A shows a block diagram 100 illustrating an assay analysis process, according to one embodiment of the invention. In block 102, an assay is produced that contains numerous sample compounds on a receiving layer, such as a gel. To generate the assay, compound dots are placed in an array pattern on a supporting layer, e.g., a ChemCard, and transferred to a receiving layer and allowed to incubate for a suitable period. In one embodiment, the dot pattern for placement of compounds in an array is that of the co-pending application entitled SPOTTING PATTERN FOR PLACEMENT OF COMPOUNDS IN AN ARRAY, application Ser. No. 60/403,729 filed Aug. 13, 2002, the entirety of which is incorporated by reference. In block 104, the assay is imaged and a digital representation of the assay, or “gel image,” is produced. The imaging methods may include, but are not limited to, using a CCD camera, photographing the assay on film and scanning the developed film or the negative, or by a spectrophometric scanner. At block 106 the digital representation 125 is provided to a computer and processed to identify information contained therein relating to the tested sample compounds. The digital representation 125 is processed by a feature finding module on the computer that may first align the image, registering it so that locations in the image may be correlated to positions in a known sample pattern, and then identify desired features, e.g., spots, in the image. At block 108, the resulting identified features of the digital representation 125 are provided as an output, for example, as a list of assay dot locations that correspond to the compounds that generated the features, according to one embodiment. A visual representation of the results may also be provided as an output at block 108, according to one embodiment. The output of the results can also include information describing specific characteristics of the identified features to facilitate additional evaluation of the features by another person or process, according to one embodiment. A list of assay dot locations resulting from this process can then be correlated to the actual sample compounds used to form the dots by referencing the placement pattern originally used for placing the dots on the supporting layer, and further testing may be conducted on the actual sample compounds, if desired.

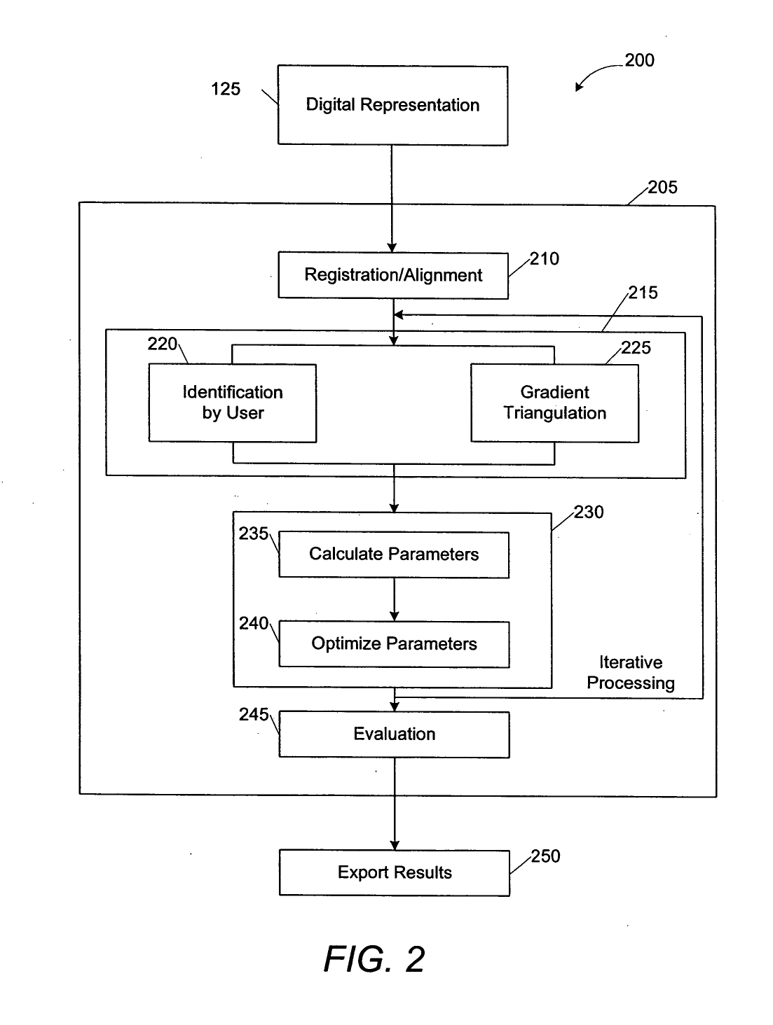

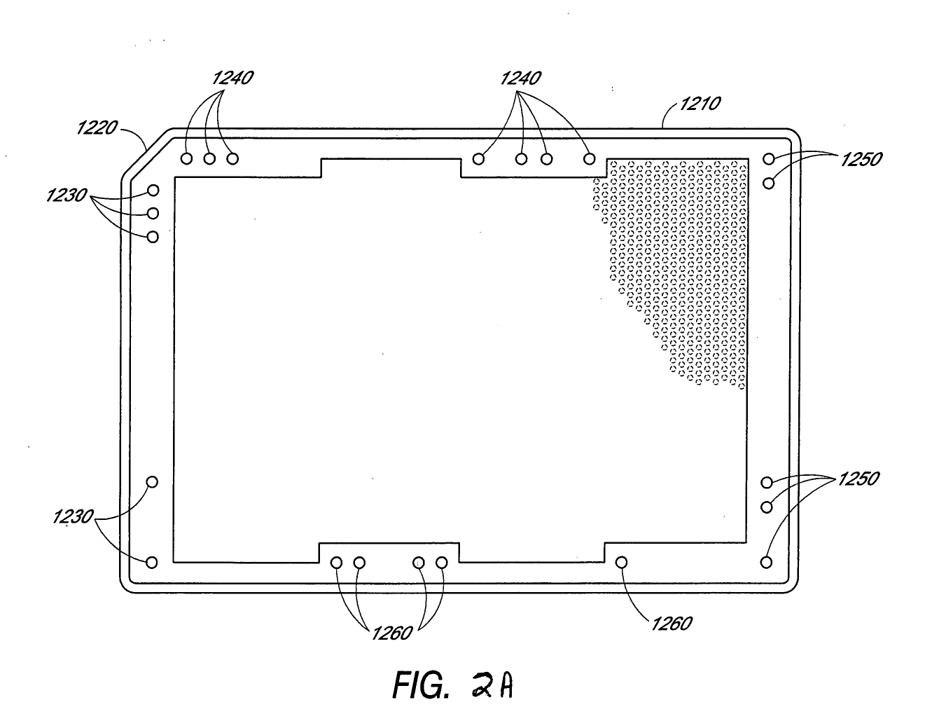

FIG. 2 shows a feature finding module 205 that can be used to identify features in the digital representation, according to one embodiment. As shown in FIG. 2, a digital representation 125 is provided to a feature finding module 205. The digital representation 125 may have been previously filtered to remove noise before it is processed by the feature finding module 205. Feature finding module 130 can contain a registration/alignment module 210 which registers the digital representation to a known coordinate system using one or more alignment spots that have known true positions and that are present in the digital representation 125. According to one embodiment, the digital representation 125 may be displayed as a viewable image enabling the user to manually align the displayed alignment spots in the digital representation 125 by providing input indicating the location of the alignment spots in the digital representation 125.

To form an alignment spot, an alignment dot may be placed in a known location in the gel assay, the alignment dot being a sample compound that will transfer a color or form a spot in the gel. The resulting spot from the alignment dot will appear in approximately the same location in the digital representation 125, thus facilitating efficient manual registration by allowing a user to map the alignment spot location of the digital representation 125 to the corresponding alignment dot location in the assay pattern. In one embodiment, a plurality of alignment dots are placed in a known pattern on the gel assay, thus forming a plurality of alignment spots in the gel assay which can also be seen in the digital representation. A plurality of alignment dots may be placed near two or more edges of the gel assay, facilitating more accurate registration, according to one embodiment.

One example of a process that may be used to align a received digital representation 125 is now described, according to one embodiment of the invention. Before any alignment spots or hit spots are identified, the user can rotate, flip (horizontally, vertically, or both), and crop the digital representation 125 using image manipulation software tools. These manipulations are recorded in a database and can be performed on an image before it is displayed. The image manipulations are typically not saved back into the original digital representation 125; instead, other images, or bitmaps, are generated which can include these changes. A bitmap in memory that results from these manipulations (hereafter the “Preprocessed Bitmap”) is displayed as an image and used for viewing and spot finding in the steps described below. The portion of the digital representation 125 that was cropped out is ignored. Specifically, the pixel in the upper left corner of the Preprocessed Bitmap is considered pixel 0,0 in the following steps. Pixel location X increases to the right of a displayed image and pixel location Y increases down the displayed image.

Before manual image alignment begins, the software may draw user-moveable alignment markers in nominal locations on a displayed image. The pixel locations for the nominal locations on the image may be computed using two assumptions, according to one embodiment. First, it is assumed that the image is reasonably well cropped and that the margin outside of the rectangle formed by alignment spots is roughly 10% of the height or width of the image. Second, it is assumed that the true position of the alignment spots is known. These coordinates are converted into pixel coordinates, as discussed below.

For manual alignment, the user clicks on a marker and moves it to a desired position, indicating the position of an alignment spot. Windows mouse events use twips as arguments for positioning. A twip is a screen-independent unit used to ensure that the proportion of screen elements are the same on all display systems. A twip is defined as being 1/1440 of an inch. The marker position, as indicated by the twips location, is used to compute the pixel coordinates on the image.

The pixel coordinates of the marker location are saved in an object that defines the marker. Regardless of how that image may be magnified, rotated or shifted, this pixel location anchors the marker to the same place on the image. The markers' displayed size is constant, regardless of the zoom-in/zoom-out level. This allows the markers to be large enough for the user to see, but no bigger than necessary. If the user zooms in to better see a spot, making the marker bigger may obscure the spot, thus inhibiting the purpose of zooming in.

As shown in FIG. 2A, true position coordinates represent the actual locations on a supporting layer, for example a ChemCard 1210, relative to where dots were placed, according to one embodiment. Alignment spots have reference designators indicated as follows: the origin (X=0.0, Y=0.0) is near the upper left corner which has a notch 1220; the left edge column of alignment dots 1230 (“L1-L5”) have X=0; the top row of alignment dots 1240 (“T1-T7”) have Y=0; the alignment dots along the right edge 1250 (“R1-R5”) have X=115.6105; the alignment dots along the bottom edge 1260 (“B1-B5”) have Y=74.25. The alignment spots may be used to compute the following factors for image alignment:

| Parameter | Units | Description |
|---|---|---|
| Theta | radians | Theta is the angle used for rotational correction. |
| | | This may be done before scaling and offset |
| | | adjustments in the process of converting a pixel |
| | | location on the image into a true position on the |
| | | ChemCard. Rotation occurs about the image |
| | | origin (pixel 0,0) of the image. As the units are in |
| | | radians, a positive angle means the image is |
| | | rotated counter-clockwise. |
| ScaleX, | pixel/mm | ScaleX and ScaleY are image scaling factors. |
| ScaleY | | After a pixel location is rotated about the image |
| | | origin, these factors are multiplied times its |
| | | coordinates to convert pixels to mm. The ScaleX |
| | | and ScaleY factors enlarge or diminish the |
| | | rectangle that was rotated about its upper left |
| | | corner by Theta to achieve mm units. |
| Xoffset, | mm | After rotating and scaling image coordinates, |
| Yoffset | | Xoffset and Yoffset are the values that needs to |
| | | be subtracted to achieve the true X, Y position. |

The image to actual coordinate conversion may be performed using the following equations:
X_{actual}=(X_{image} cos θ+Y_{image} sin θ)/Xscale−Xoffset
Y_{actual}=(Y_{image} cos θ−X_{image} sin θ)/Yscale−Yoffset
The above transformation may be performed using matrices. According to the embodiment described herein, simple formulas rather than matrices are used.

The inverse transform of the above is used to convert from actual coordinates to image coordinates. This may be done when displaying unverified alignment spot markers. The known actual locations are converted to image coordinates. These markers are displayed as a different color to show that the user did not explicitly align. If the positions they appear in are well aligned, this is an indication that the alignment process was successful. Also, actual coordinates may be converted to image coordinates when displaying hit spot markers. Hit spot data is stored in the data base as actual coordinates. It is necessary to convert these between coordinate systems when going back and forth between the database and image displays. The equations for converting from actual coordinates to image coordinates are:
X_{image}=Xₜ cos θ−Yₜ sin θ
Y_{image}=Yₜ cos θ+Xₜ sin θ
where:
Xₜ=Xscale(X_{actual}+Xoffset)
Yₜ=Yscale(Y_{actual}+Yoffset)

During the interactive alignment process, alignment markers are color coded to indicate if they are verified or unverified. Unverified markers are not used in the process for computing correction factors. After a user interactively positions a marker, the software assumes that the user has centered it on the right spot. The software recomputes the correction factors and adjusts the position of the unverified markers based on the updated correction factor. This provides user feedback about progress in the alignment process, and facilitates quicker alignment. After positioning two markers that span a diagonal, all of the unverified markers may naturally line up with their spots. The user could decide the alignment is sufficient and move on to finding spots. If, however, an unverified marker appears too far out of position, the user can adjust it, and a better overall fit may be achieved. The software can include the ability to “unverify” a marker, thus allowing additional flexibility.

According to one embodiment of the invention, when computing the correction factors, theta may be computed first, then the rotational correction with theta may be performed, scale factors may then be computed, and finally the offset factors may be computed. Theta may be computed as follows, for one embodiment of the invention. For each pair of verified markers, an angular error is computed as follows:
δ=φ_{actual}−φₜᵣᵤₑ
where φ=tan⁻¹((Yᵢ−Yⱼ)/(Xᵢ−Xⱼ))
for the true and user designated positions of markers i, j.

Thus, each δ represents how much the image needs to be rotated to make the imaginary line segment connecting its two alignment spots be at the same angle it would be at in a perfectly squared up ChemCard in its normal viewing orientation (i.e., with notched corner 1220 positioned at upper left). Any φ greater than φₘₐₓ) (for example, π/6 is suggested) is not credible and is not used. This would likely be due to user error, for example, a marker may have been moved to a wholly incorrect location. The software can notify the user of this problem, allowing an errant marker to be “unverified” or the software may not change the marker's status from unverified to verified in the first place. According to one embodiment, the image may be rotated and flipped to an orientation that is close enough to normal to pass the φₘₐₓ test before allowing alignment to proceed.

With each new marker that is verified, Theta may be computed as a weighted average of all values. Because a greater distance between two markers lends it greater credibility in providing an indication of rotational error, the distance between the markers is used as the weight as follows:
θ=Σδᵢdᵢ/Σdᵢ
where dᵢ is the distance between the two alignment spots j and k:
   dᵢ=((Yⱼ−Yₖ)²+(Xⱼ−Xₖ)²)^{1/2}

The scale factors ScaleX, ScaleY are computed as follows, according to one embodiment of the invention. After Theta is computed, temporary values are computed representing the verified marker positions after a rotational correction using theta. This is a necessary step before computing scale factors. To illustrate the latter point, suppose there were two markers which should be on the same horizontal line separated by 100 mm. Suppose the image is rotated 45° and in terms of the image, the markers are separated a distance of 100 pixels. Obviously the scale factors for X and Y are 1 mm/pixel. However, the X distance between the markers, because of the angular error, is about 71 pixels (100 √2/2=70.707). Thus, as described in this embodiment, rotational correction must be applied before determining scale factors. As in the theta computation, a weighted average may be used, with weights determined by the relative lengths of inter-marker distance. First, the scale factor contribution from each pair of markers is computed (formulas are shown for X, Y formulas are similar):
Sₓᵢ=((X_{j true}−X_{k true})/(X_{j pixel}−X_{k pixel}))

Next the median value may be computed. Any of the above individual scale factors that differ from the median by too much may be ignored. The constant SEₘₐₓ (suggested value: 0.1, according to one embodiment) is used to determine this validity as follows:
(1/(1+SEₘₐₓ))S_{median}<Sₓᵢ<(1+SEₘₐₓ)S_{median} for all valid Sₓᵢ
The above check may be performed when there are more than two verified alignment spots.

Finally, the overall scale factor is computed as a weighted average of all of the contributing scale factors that pass the above close-to-the-median test:
ScaleX=ΣSₓᵢdᵢ/Σdᵢ
where again, dᵢ is the distance between the two alignment spots j and k:
   dᵢ=((Yⱼ−Yₖ)²+(Xⱼ−Xₖ)²)^{1/2}

The offset factors Xoffset and Yoffset may be computed as follows, according to one embodiment of the invention. After the above scale factor is computed, the temporary values representing the verified marker positions that were rotationally corrected are scaled using the scale factor computed above. A method similar to the scale factor computation may be used to compute the offset factor. First, the offset factor contribution from each individual markers is computed (formulas are shown for X; Y formulas are similar):
Oₓᵢ=X_{i true}−X_{i computed}
O_{yi}=Y_{i true}−Y_{i computed}
Next the median value of these individual factors is computed. Any of the above individual factors that differ from the median by more than may be ignored. A value of Oₘₐₓ may be 2.0 mm, according to one embodiment of the invention. Finally, the offset factor is computed as a simple average of all of the individual factors that passed the above test:
Xoffset=ΣOₓᵢ/n
Yoffset=ΣO_{yi}/n
The above-described process and computations for image alignment are not meant to be limiting but only descriptive of an alignment process, according to one embodiment of the invention.

If the relative locations of the alignment spots are known, the digital representation 125 may be automatically aligned by a pattern matching technique that uses the approximate known relative locations of the alignment spots as a starting point and performs a best fit operation to the alignment spots automatically identified in the digital representation 125. In FIG. 2, the Registration/alignment module 210 may also perform a semi-automatic process where a user first approximately identifies the locations of alignment spots in the digital representation 125 and then these locations are used as an input to an automatic alignment process that finds the precise location of the alignment spots, based on the user's input, the known relative location of the alignment spots and the spot finding techniques described below. In another embodiment, a pair of hit spots may be used to align the image, using their location to indicate which locations in the image correspond to known locations in sample compound pattern. As additional pairs of hit spots are identified, they can also be used to further align the image in an iterative manner. In yet another embodiment, alignment factors (e.g., x,y scale, x,y offset, and/or theta rotation) can be calculated for every pixel in the image to compensate for non-linear distortion.

Registration of the digital representation 125 also helps correct for distortion that may have occurred in the imaging system. All optical systems have some inherent distortion, such as pincushion or barrel distortion. Because the dots are placed on the gel in a specific pattern, the centers of the resulting spots must fit closely with the pattern. As distortion in the digital representation 125 tends to be smooth rather than abrupt, it is possible to map the distortion during the registration/alignment process. For example, a calibration grid can be used to correct the distortion, according to one embodiment. A plurality of alignment spots appearing in the digital representation 125 may be advantageously used to correct for distortion from the optical system in captured images. In one embodiment, a plurality of alignment spots appearing near all four edges of the digital representation 125 are used to correct for distortion as they may provide a pattern on the image where the relative location of each alignment spot is known. By comparing the pattern of alignment spots appearing in the digital representation 125 to the known location of the alignment dots, a distortion correction value may be generated for the digital representation 125. By correcting the digital representation 125 or the spot X₀ and Y₀ coordinates, the accuracy of the identification process can be improved.

After the digital representation 125 is aligned, it is processed to find features, or hit spots, based partly on the concept that developed spots are circular in nature. As shown in FIG. 2, spot finding is basically a two-step process. A spot finding module 215 identifies the locations of spots in the digital representation 125, and then a spot function module 230 models the spots to identify hit spots. Because the processing required to evaluate the spot function at every point on the image can be relatively time consuming, identifying spot locations first is an alternative approach that may be used to determine initial positions for processing by the spot function. Spot locations may be identified either manually through interaction with a user by an identification by user module 220 or automatically by image processing with a gradient triangulation module 225. Interactive spot identification by a user may be subjective and requires special user training and experience. However, once learned, interactive spot identification is an efficient technique that may be especially useful to quickly identify spots in some instances, e.g., when the spots are few in number and generally distinct. To identify a spot location, the user may indicate to the software program the location(s) on the displayed image where the spot exists. The gradient triangulation module 225 performs an image processing technique that may also be used to automatically and quickly determine spots in the digital representation 125, and is described in more detail below. In either case, the spot locations may be used as the input locations for the spot function processing.

Modeling the spots by the spot function module 230 is done in two steps. First, for each spot location, an initial set of parameters that describe the spot are calculated. Examples of spot parameters that may be used include a radius of the spot, an amplitude of the intensity values of the spot, a flatness of the spot indicating how aggressively flattening occurs at the top of the spot, a “sigma” of the spot indicating at what distance from the spot center that the intensity is half way between the center intensity and the background intensity, a flattening threshold indicating where flattening of the normal gaussian spot shape takes place, and a base value, which is the estimated average background level under the spot in pixel intensity units. Parameters for the spot and the spot function are described in detail in a following section of this paper. An initial value that indicates a measure of fitness between the spot function and the digital representation at the spot location is then calculated. For example, the value can be based on intensity or size, or a more complex value can be calculated. In one embodiment, an initial correlation value between the spot function and the digital representation 125 at the spot location, as described by its calculated parameters, is calculated by the calculate parameters module 235. The correlation value gives a measure of fitness between the spot modeling function and the digital representation 125, i.e., how well the data in the digital representation 125 at the spot location matches a theoretically modeled spot as defined by the spot modeling function. The correlation value is independent of the background and the amplitude of the spot, so that even faint spots can still correlate highly. The correlation value will start to degrade with increased noise or interference from overlapping spots. The basic meaning of the correlation value is the fraction, or percent, of the image variation that is explained by the spot function. Because this calculation takes place across a large number of pixels, this statistic is relatively insensitive to noise. Spots with correlation values above a threshold value are saved in a list for the second step of the process in which the parameter values are refined.

In the second step of the spot function module 230, an optimize parameter module 240 processes the spots from the list one at a time and optimizes their parameters. During optimization, a spot's parameters are recalculated from the digital representation 125, using data slightly varied from the data of the digital representation 125, and another correlation value is calculated. An increase in the correlation value indicates that the optimized spot parameters produce a better fit with the spot function and therefore more accurately describe the spot. Optimization may be performed in iterations, each time slightly varying the calculated parameters and then recalculating a new correlation value until further parameter changes do not produce a higher correlation value, or until a designated correlation value has been achieved. The spots remaining on the list after optimization are the identified hit spots.

During optimization, the highest correlating spot on the list, i.e., the spot with the highest correlation value, is processed first, according to one embodiment. As the parameters are optimized, the correlation of the spot function with the image may increase. A median error function may be used in the optimization process to minimize the effects of overlapping spots on the parameter values, according to one embodiment. Once the parameters for a spot are optimized, the information relating to the spot may be removed or subtracted from the image so that the image no longer depicts the spot. According to one embodiment, removal of the spot from the image is based on its optimized spot parameters, e.g., the optimized parameters that model or define the spot in the image can also be used to define what information can be removed from the image so that the spot no longer appears in the image. By removing the information related to the spot from the image, the effects of the higher correlating spot on adjacent and overlapping spots may be minimized. Once the information relating to the spot is removed, the correlation of the remaining spots can be recalculated to insure that the remaining spots are still properly ranked on the list. The optimization process is repeated until all spots on the list have been optimized. If at any point, an optimized spot does not achieve a high correlation value, indicating that it may not be a hit spot, it can be removed from the list and the image will not be modified.

According to one embodiment, the feature finding module can perform iterative processing of the digital image representation 125 to identify features. For example, the hit spots on the list can all be removed from the image and the image can then be processed again by the spot finding module 215 and the spot function module 230. Iterative processing may identify additional spots that did not at first meet the sufficiency criteria to be designated as hit spots, possibly due to the influence of other more predominant spots in the image when it was first processed.

Once the parameters for the identified hit spots have been optimized, an evaluation module 245 evaluates the spots and makes adjustments to the list, for example, if desired by the user, according to one embodiment. If the digital representation 125 is displayed during spot identification, the user may review the list of spots and, during this process, the particular area of the digital representation 125 corresponding to the spot location being reviewed may be displayed to facilitate evaluation of the results. Once desired adjustments, if any, have been made, an export results module 250 exports the results in a suitable format and they may be used to identify an assay sample compound that generated a hit spot.

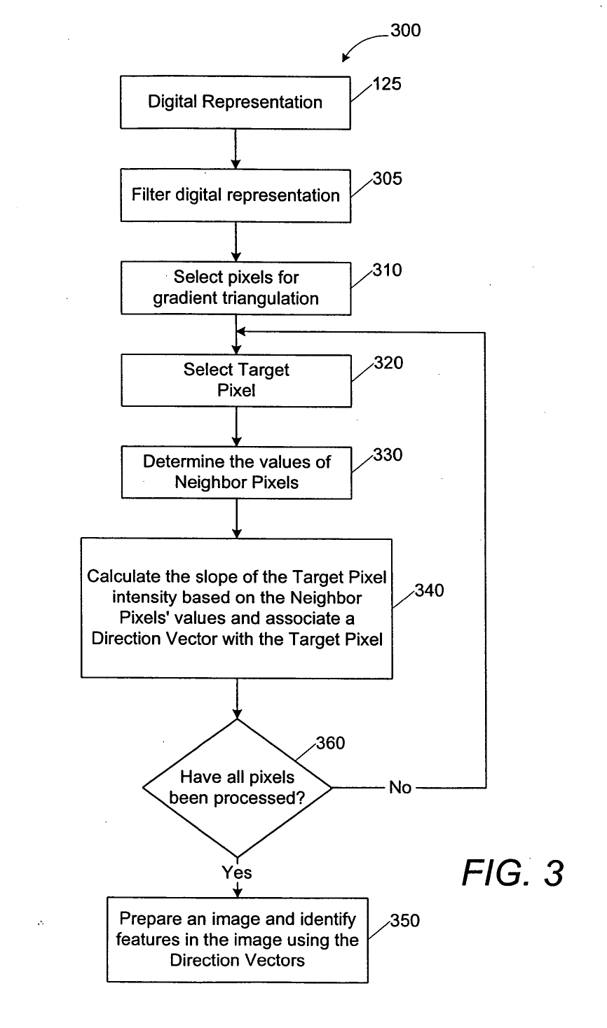

FIG. 3 is a flow diagram showing the steps for gradient triangulation, a method for automatically identifying features in an image, according to one embodiment. These steps may be incorporated as a computer program in, e.g., the gradient triangulation module 225. At block 305, the digital representation 125 can be pre-processed to remove noise, e.g., speckles, high frequency noise or low frequency noise. In one embodiment of the invention, a smoothing filter is applied to the digital image representation 125. At block 310, a set of pixels is selected for gradient triangulation from the digital representation 125. According to one embodiment, all the pixels in the digital representation 125 are selected for gradient triangulation. According to another embodiment, a subset of the pixels in the digital representation 125 are selected for gradient triangulation, based on, for example, user defined cropping of the digital representation 125.

At block 320 a target pixel is selected from the set of pixels. At block 330, the intensity values of neighbor pixels in a subimage surrounding the target pixel are determined. Next at block 340 the slope of the target pixel is calculated based on the intensity values of its neighboring pixels and a direction vector is associated with the target pixel. The slope of the target pixel is defined as the direction of the greatest change in the intensity values of the target pixel's neighboring pixels. A direction vector, also referred to herein as an intensity slope vector, is then associated with the target pixel, where the intensity slope vector originates at the target pixel location and points in the direction of the target pixel's slope. Depending on the type of spot in the image, the direction vector will point in the direction of a maximum increase or decrease in pixel intensity. At block 360, the pixels in the subimage are evaluated to see if they have all been processed, and if not, a new target pixel is selected and processed in blocks 330 and 340. This process can be repeated until each pixel in the set of selected pixels is processed. That is, each pixel in the set of selected pixels is processed as a target pixel, calculating the slope of each pixel and associating a direction vector with each pixel. At block 350 an image or data map is prepared that includes a set of pixels and symbols or data representing the direction vectors, where the combined symbols in the image identify features, e.g., spot locations.

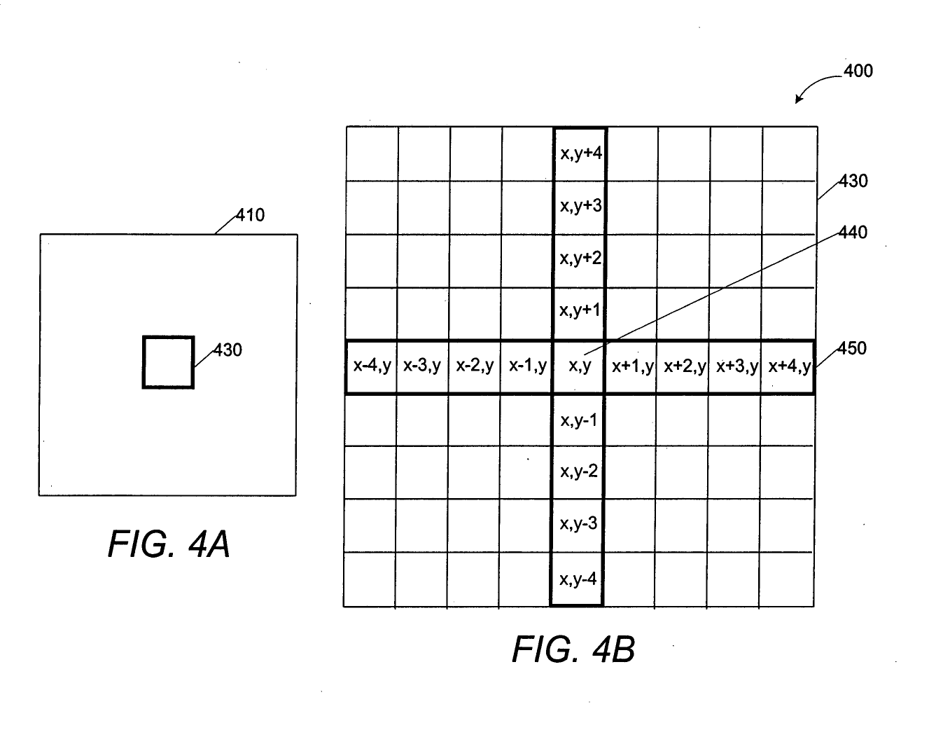

FIG. 4A and FIG. 4B further illustrate gradient triangulation. In FIG. 4A, a subset of pixels 430 is shown as part of a set of selected pixels 410 used for gradient triangulation. FIG. 4B shows the subset of pixels 430 containing a target pixel 440 and a subimage of neighbor pixels 450, according to one embodiment. In FIG. 4B, target pixel 440 is labeled as pixel (x,y). Subimage 450 is shown to contain certain pixels in the 9×9 pixel set 430, including pixels (x−4,y), (x−3,y), (x−2,y), (x−1,y), (x+1,y), (x+2,y), (x+3,y), (x+4,y), (x,y+1), (x,y+2), (x,y+3), (x,y+4), (x,y−1), (x,y−2), (x,y−3), and (x,y−4), according to one embodiment. Although only certain neighbor pixels are shown, more or fewer neighbor pixels located in any direction can be included in the analysis. Various other subimage configurations containing neighbor pixels of the target pixel 440 but differing in size and shape to subimage 450 may be used, according to other embodiments. Including more pixels in the subimage of neighboring pixels may increase accuracy and lessen the effect of “noise” in the data. Including fewer pixels in the subimage 450 will generally increase processing speed. It should be noted here that the terms “image”, “subimage” or “pixels” as used herein at various locations do not necessarily mean an optical image, subimage or pixels which are either usually displayed or printed, but rather include digital representations or other representations of such image, subimage or pixels. The slope of the target pixel's 440 intensity in the selected set of pixels 410 is calculated by determining the intensity value of each pixel included in the subimage of neighbor pixels 450 centered at the target pixel. The slope of the intensity of the target pixel 440 intensity will be a direction representative of maximum change, or rate of change, of intensity at the target pixel into the intensity of its neighboring pixels. While this disclosure discusses pixels, it should be noted that a multi-pixel region of the image can be substituted for an individual pixel throughout this disclosure.

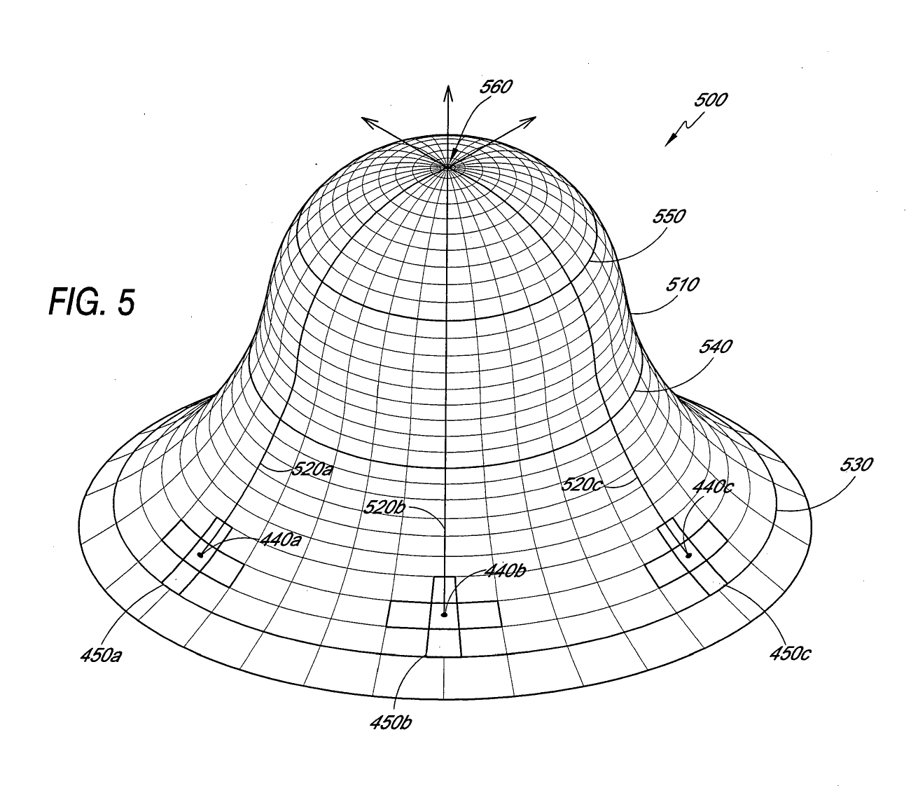

FIG. 5 illustrates an example of associating a direction vector with a target pixel's intensity slope. A feature profile 510 that may occur in a digital representation 125 is shown in a three dimensional feature profile illustration 500. The feature profile 510 is formed by showing the intensity values for a set of pixels depicting a spot as the height, z, at a position, x and y in the digital representation 125. The intensity value for pixels that depict the feature profile 510 is greater at the center or “top” 560 of the feature profile than at pixel locations on the sides 550, 540 of the feature profile, i.e., pixels located farther away from the center of the spot. As the distance x or y from the center 560 of the feature profile 510 increases, the intensity value of the pixels correspondingly decreases so that the intensity value of pixels near the bottom of the feature profile 530 are lower than pixel intensity values near the sides of the feature profile 550, 540.

The three dimensional feature illustration 500 also shows a representation of a subimage 450a containing a target pixel 440a located on the feature profile 510. The target pixel 440a has an associated direction vector 520a that indicates the target pixel's intensity slope. Assuming the spots are “dark,” the intensity value of pixels that depict spots generally increase near the center of the spot, thus many target pixels located on the spot will have a calculated slope direction pointing towards the center of the spot, as that will generally be the direction of the maximum change or rate of change of the target pixel's intensity relative to the intensity of its neighboring pixels. The direction vector 520a originating at target pixel 440a and drawn in the direction of the center 560 of the spot profile 510 illustrates a direction vector pointing in direction of the center location of the spot. Similarly, target pixels 440b, 440c in other representations of subimages 450b, 450c located on the spot have associated direction vectors 520b, 520c that are also in a direction towards the center 560 of the spot profile 510. The three target pixels 440a, 440b and 440c and subimages 450a, 450b, 450c shown in FIG. 5 are a representative sample of the numerous target pixels and subimages that may be used to determine direction vectors in gradient triangulation. During gradient triangulation, each pixel in the selected pixel set may be evaluated as a target pixel and the resulting direction vector can be used to help determine spot, or feature, locations.

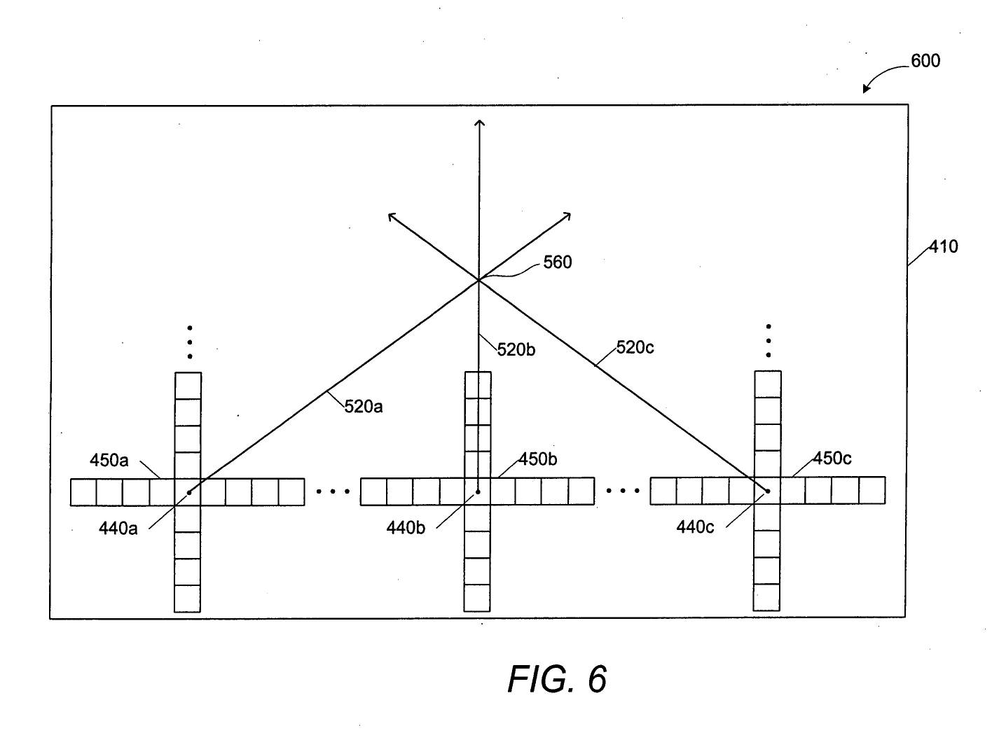

FIG. 6 further illustrates gradient triangulation and represents the same subimages, target pixels and associated direction vectors shown in FIG. 5, but in FIG. 6 these are shown in a two-dimensional view. Subimage 450a containing a target pixel 440a is located on a set of pixels 410 selected for processing by the gradient triangulation module 225, as shown in FIG. 2. The target pixel 440a has an associated vector 520a that indicates the direction representative of the maximum change or rate of change of intensity at the target pixel into the intensity of its neighboring pixels. Similarly, other subimages 450b, 450c that contain target pixels 440b, 440c are also located on a set of pixels 410, and have vectors 520b, 520c associated with the target pixels 440b, 440c that indicate the direction representative of the maximum change or rate of change of intensity at the target pixel into the intensity of its neighboring pixels. The length of the direction vector may be optimized either automatically or empirically, and the length may relate to the size of the spots expected or observed in any particular case. When the direction vectors 520a, 520b, 520c are graphically depicted, they pass through a common point 560. Because the direction vectors represent the direction of the maximum intensity change at each target pixel, the point 560 indicates a common location in the set of pixels 410 that was determined to be in the direction of the maximum intensity change for all three target pixels 440a, 440b, 440c. Assuming that desired features in the set of pixels 410 are substantially circular, the common location 560 is indicative of the center of a spot.

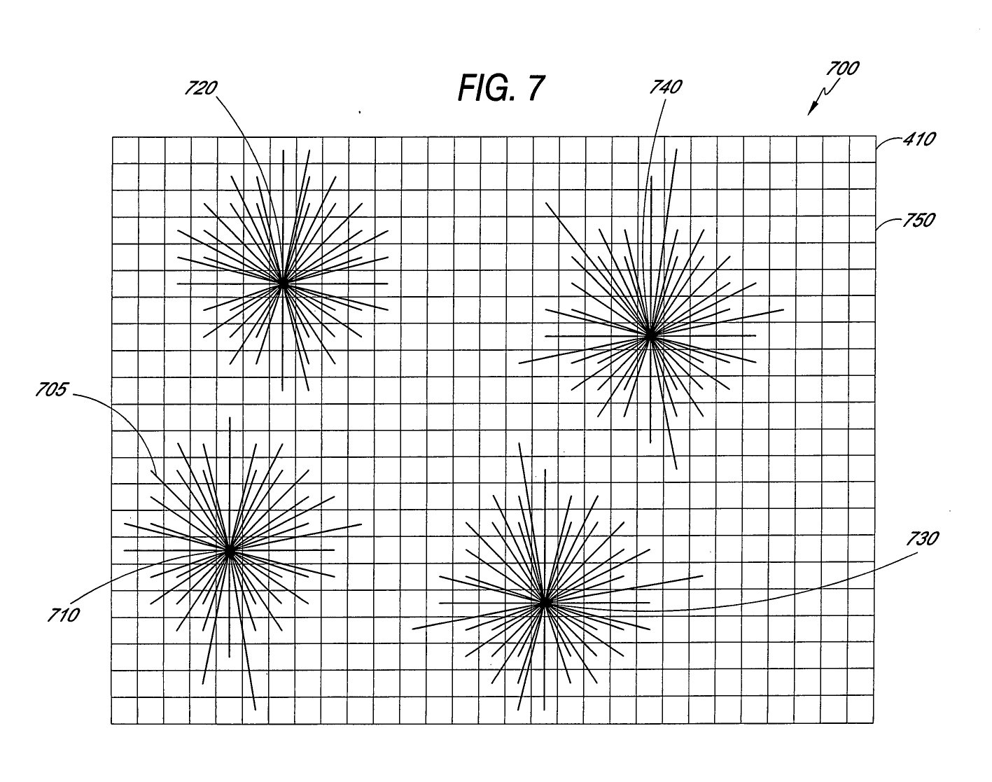

FIG. 7 illustrates an image 750 prepared by combining a plurality of symbols 705 of numerous direction vectors drawn from target pixels in the selected set of pixels 410. Use of a plurality of symbols 705 is one preferred method for ascertaining convergence or divergence of vectors. When the plurality of symbols 705 are depicted in an area near the location of a spot, the symbols project from the target pixels through common locations 710, 720, 730, 740 and indicate that the common locations 710, 720, 730, 740 may be the center of a spot. As more symbols 705 combine at a common location, the likelihood that the common location is the center of a spot increases.

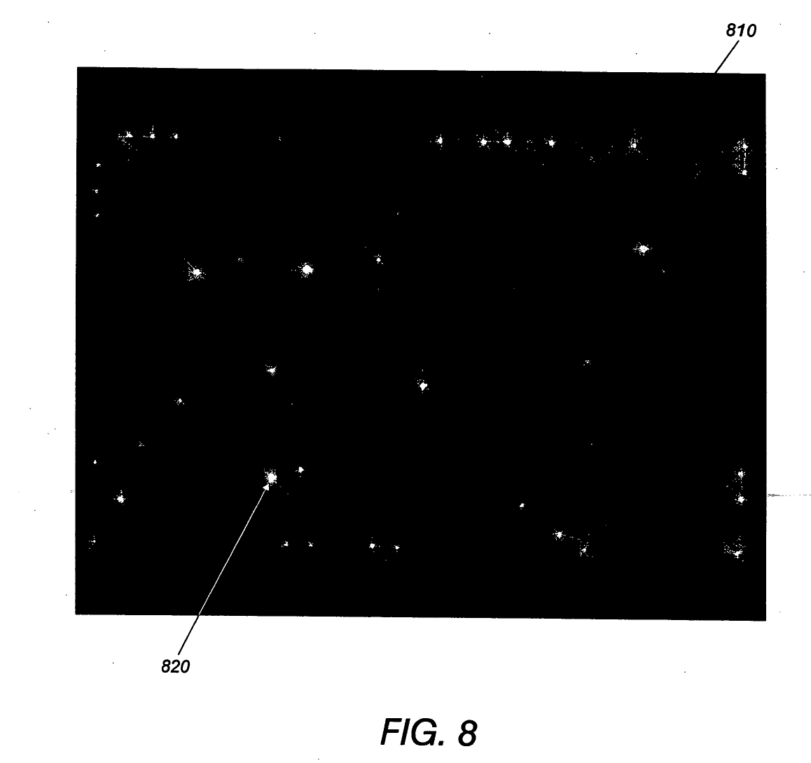

FIG. 8 is an image that illustrates the result of combining symbols for direction vectors for each pixel in a set of pixels 410 (FIG. 4A) to indicate the center locations of spots, according to one embodiment. Of course, any suitable method that determines the location of a convergence or divergence of vectors can be used to indicate the center location of a spot. The image 810 was made by generating an image with pixels corresponding to the selected set of pixels 410 and setting the intensity value for all the pixels to “0” so the prepared image 810 would initially be black. Direction vectors were calculated for each pixel in the set of pixels 410. Symbols representing the direction vectors were depicted in the prepared image 810 such that the symbols originated at pixels in the prepared image 810 that correspond in relative location to the target pixels in the set of pixels 410 selected for gradient triangulation. The symbols in the prepared image 810 have a common intensity value that is greater than zero. When symbols overlap in the prepared image 810, the intensity value of the pixel located at the overlap location will be combined, i.e., increased, to form a larger intensity value, or “peak” value. The peaks 820 in the prepared image 810 indicates a point where symbols overlap, and as the number of symbols overlapping at a particular pixel location increases, the intensity value of the pixel at that location similarly increases, and the peaks become “higher.” Once the symbols for the selected set of pixels 410 are represented in the prepared image 810, the peaks in the prepared image 810 are evaluated and used to identify spot locations at the corresponding pixel location in the selected in the set of pixels 410.

To evaluate the peaks in the prepared image 810 a threshold value can be selected and applied to the peaks in the prepared image 810, according to one embodiment. If a peak in the prepared image 810 has an intensity value above the threshold value, a spot will be deemed to exist at the corresponding pixel location in the selected set of pixels 410. Thresholding techniques are well known to persons of skill in the art and may be implemented in a variety of ways, including having the user select a threshold or having the threshold automatically determined based on the number of peaks found and their intensity value. A threshold for gradient triangulation can be selected so that there is a low probability of excluding actual spot locations, thus allowing a sufficient number of spot locations to be selected for further analysis.

An identified spot location indicates a location in the digital representation 125 that requires further analysis to determine if the location corresponds to a hit spot or signal. A spot function may be used to help analyze information in the digital representation 125 at the spot location, according to one embodiment. Spot finding methodology using the spot function is a parametric approach that decomposes a digital representation 125 into a set of spots and a background, and then models the characteristics of a spot. The background of a digital representation 125, i.e., information contained in the digital representation 125 that is not a result of an assay response, or signal, to an “active” compound can be irregular for various reasons. For example, irregularities in the background can be caused by gel distortions, variations in the chemical composition of the gel, uneven lighting of the gel during the imaging process, uneven brightness due to lens related issues during the imaging process, and imperfections in the gel itself including the presence of dust or other opaque or reflective material. If the gel can be imaged before the incubation period, i.e., before the reaction that produces the spots takes place, then this “before reaction” image can be used to define the background for subsequent images by subtracting the background from the subsequent images prior to applying spot finding techniques, according to one embodiment.

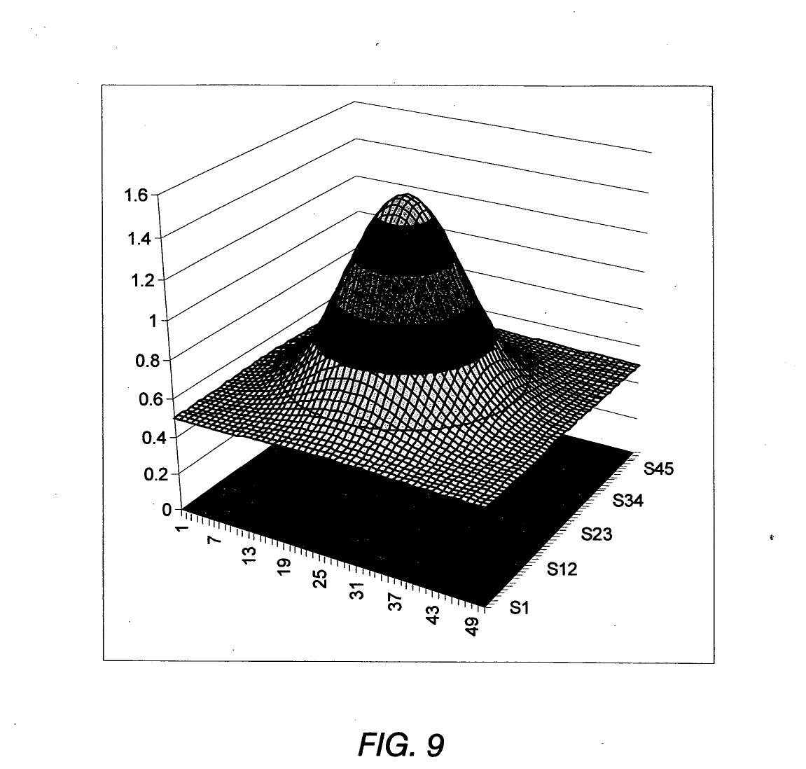

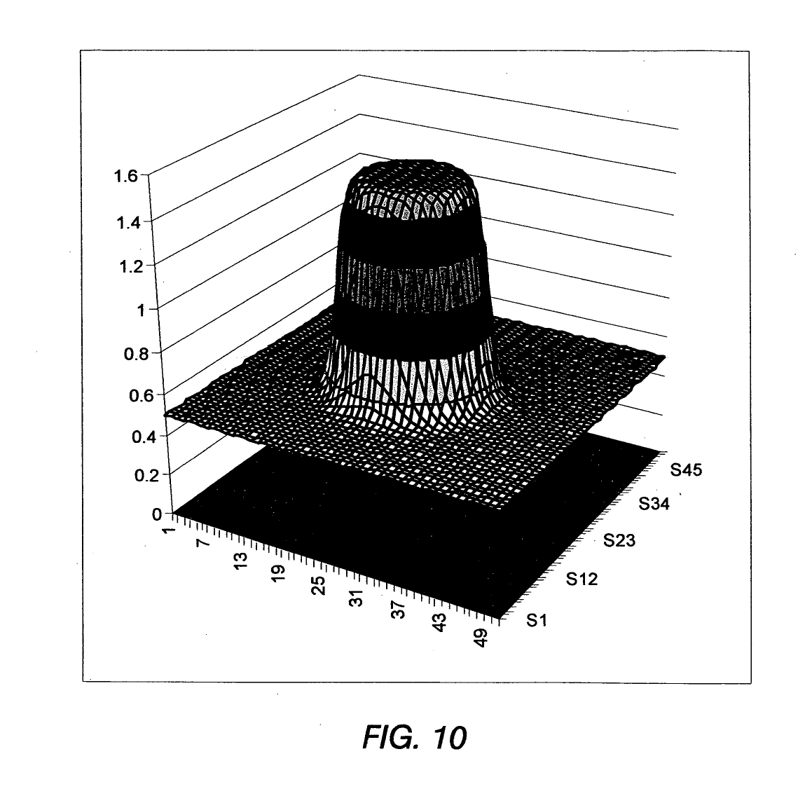

The parametric approach to finding and generating statistics related to spots requires a model of what a spot may look like under certain conditions. Due to the underlying diffusion process, most small spots have a basic gaussian shape when the intensity as a function of its x,y position is plotted as the z axis. FIG. 9 illustrates the shape of a spot with a basic gaussian shape. As the spot becomes larger and more dense, limits are reached due to the gel thickness and/or the imaging system that tend to flatten or threshold the basic gaussian shape. For example, FIG. 10 illustrates the shape of a spot that is flattened due to limiting factors. By modeling the flattened spot characteristics with the spot function, and comparing the spots found in an image with the model of a spot, finding spots becomes more effective because the spots in the image are objectively evaluated using parametric data.

The following detailed description of spot modeling characteristics is provided according to one embodiment of the invention. It will be appreciated, however, that no matter how detailed individual modeling characteristics are described, the invention can be practiced in many ways.

To generate a model for a spot the following parameters may be defined:
X₀: The x position of the spot in the gel image.
Y₀: The y position of the spot in the gel image.
BASE: The value of the background intensity in the gel image.
AMP: The amplitude of the spot that represents the difference between the intensity of the spot at its center and the background intensity of the gel image.
SIG: The “sigma” factor describing at what distance from the spot center that the intensity is half way between the spot's center intensity and the background intensity of the gel image.
FF: The flatness factor determines the amount that the basic gaussian shape has been subjected to the threshold of the medium or squashed, i.e., how aggressively flattening occurs at the top of the gaussian shape.
THRES: This is the flatness threshold, i.e., the value from the basic gaussian shape that becomes the half intensity point in the squashed gaussian shape.
   From the above-described parameters, the flattened gaussian shape function, F, may be defined by the following equations, according to one embodiment.

The nominal shape of the spot is defined by the following equation:
G=e^{-a((x-x}^{₀}⁾^{²}^{+(y-y}^{₀}⁾^{²}⁾
where a=0.6931471806/SIG²

To improve modeling of spots that tend to occur in the intended application, the gaussian shape is modified by FF and THRES parameters to have some or no degree of flatness in its upper region. FF defines how aggressively flattening is applied while THRES defines where in the upper region of the gaussian it begins to take effect. Intermediate values are computed as follows:
S₁=1.0/(1.0+e^{-FF*(1.0-THRES))}
S₀=1.0/(1.0+e^{-FF*(-THRES))}
S_{g}=1.0/(1.0+e^{-FF*(G-THRES))}
H=(S_{g}−S₀)/(Sᵢ−S₀)

The final function, F, defining a spot is:
F=BASE+(AMP*H)

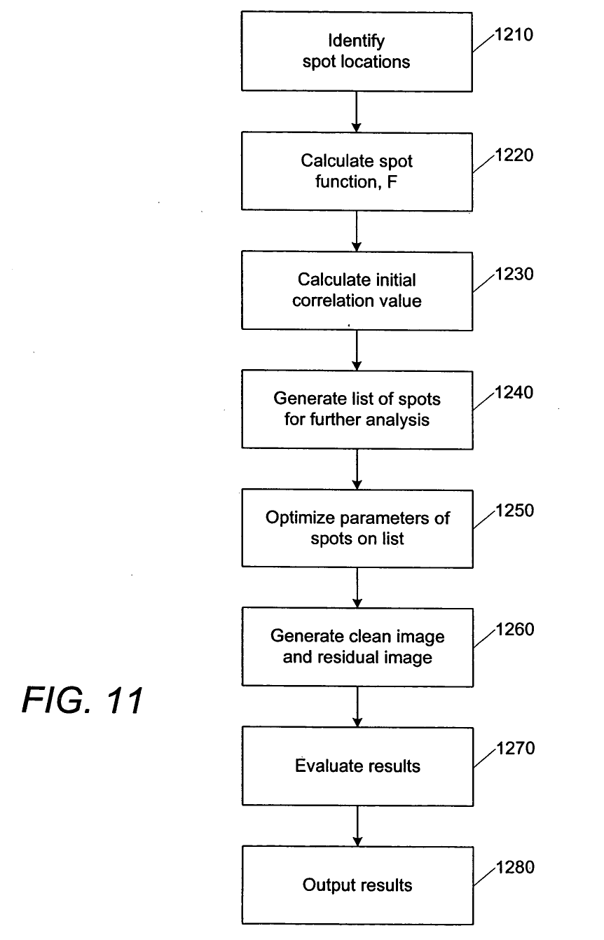

FIG. 11 illustrates a process that may be used for spot analyses using a spot function, according to one embodiment. These steps may by implemented in a computer program and incorporated in the spot function module 230. At block 1210, spot locations are initially identified using previously described techniques, for example, identification by a user through an interactive process or by gradient triangulation. At block 1220, parameters are generated that describe the digital representation 125 at each of the spot locations identified in block 1210. For example, radius, sigma, intensity, amplitude, flatness factor, flatness threshold and base are parameters of a spot that may be computed, according to one embodiment of the invention. The spot intensity parameter may be defined as the sum of pixel intensity units minus the base value, for all pixels within the radius from the spot center, according to one embodiment. The spot function, F, is also generated for the spot, thus providing a model of a spot for comparison to the actual spot.

At block 1230, an initial correlation value is calculated between the spot function, F, and the parameters, at each spot location. Correlation provides a measure of fitness between the spot function, F, and the calculated parameters that are independent of the background or amplitude of the spot. For example, the sigma of the spot in the image may be compared to the sigma of the model spot, and a correlation value may be generated to describe how well the image spot sigma “fits” the model spot sigma. Correlation values may be computed describing the fitness of one parameter or a plurality of parameters. Additionally, individual correlation values describing the fitness of any one of the parameters may be combined to provide an overall correlation value for the fitness between the spot function and the spot in the image.

Evaluation of spots formed at replicate dot locations (described further below) hereinafter referred to as “replicate spots,” may influence the determination of whether a hit spot actually exists at a particular image location. Parameters may be generated for each replicate spot and directly compared to help determine the existence of a hit spot, for example, similar calculated parameters can indicate a higher likelihood of the existence of hit spots. The computed correlation value(s) for the replicate spots can also be evaluated and used to determine whether a hit spot exists at a particular location.

Even faint spots in the image can still correlate highly. The correlation value will start to degrade with increased noise or interference from overlapping spots. The basic meaning of the correlation value is the fraction (percent) of the image variation that is explained by the spot function. The correlation value is relatively insensitive to noise because its calculation takes place across a large number of pixels, i.e., by “integrating” over a large number of pixels. At block 1240, spots with correlation values above a selected threshold value are saved in a list and subsequently used for the second step of spot modeling where the parameter values are refined. Spots with a correlation value above the threshold may also be checked for the proximity of other spots on the list to ensure that only distinct spots are selected and placed on the list. The spot locations on the list may be viewed as candidate hit spot locations if further processing is then performed to verify that the identified candidate hit spot locations actually indicate a hit spot, according to one embodiment. Alternatively, the hit spot locations identified as a result of evaluating the correlation value may be considered to indicate actual hit spot locations, without any further processing, and the hit spot locations can be correlated to a known compound placement pattern to identify sample compound locations, thus saving the time required for further verification of the spot results.

A spot on the list may be further processed to optimize its parameters 1250. In this process, the spot with the highest correlation value may be processed first, according to one embodiment. During optimization, information from the digital representation 125 is used to recalculate the parameters so that the spot more accurately correlates with the spot function, F. For example, a spot's parameters that may be recalculated during optimization include sigma, amplitude, flatness, flatness threshold, radius, and base, according to one embodiment. The optimization process may consist of a single recalculation of the parameters, or a series of iterative parameter recalculations. A new correlation value can be calculated after the parameters are recalculated. As the parameters are optimized, the correlation of the spot function with the digital representation 125 increases. When the parameters are optimized in an iterative fashion, evaluating the new correlation value against the previous correlation value at each iteration can provide an indication on whether optimization is sufficiently complete. For example, if the newly computed correlation value increases above a designated threshold, the optimization may be deemed sufficient, according to one embodiment. Also, if the correlation value reaches a peak value and additional iterative parameter computations do not result in an increase of the recomputed correlation value, optimization may also be deemed to be complete, according to another embodiment of the invention. An error function may used in the optimization process to minimize the effects of overlapping spots on the parameter values. According to one embodiment, the error function may be a median error function.

At block 1260, a clean image may be formed to show what the image would look like under perfect conditions based on the list of spots and their properties. The clean image can be a reconstruction of the original image assuming a flat background, i.e., a background with a consistent pixel intensity level, showing only the identified spots. The identified spots may also be removed from the digital representation 125 based on the optimization results, forming a “residual image.” Removing the identified spots minimizes the effects of the higher correlating spot on adjacent and overlapping spots and allows the user to see what the image looks like after subtracting the spot from it. Viewing the residual image may reveal small, left over spots that were obscured by larger ones or otherwise missed by the spot finding algorithms. Showing the user the residual image may help the user to manually pick out a handful of difficult-to-find spots, and these spots can then be analyzed using the spot function. Once the spot is removed from the image, the correlation of the remaining spots may be recalculated to insure that the remaining spots are still properly ranked. This process is repeated until all spots on the list have been optimized. If at any point an optimized spot does not achieve a high correlation value it may be removed from the list and the image will not be modified. The optimized spots that have a sufficiently high correlation value or meet other sufficient criteria can be considered hit spots. According to one embodiment, once the optimized spots are removed, the residual image is re-processed by a spot identification algorithm, e.g., gradient triangulation, and the identified spots are modeled using the process described above to possibly identify additional hit spots. This iterative processing can identify hit spots that were previously obscured by larger or more predominant spots in the digital image representation 125.

After parameter optimization is completed, at block 1270 a user can evaluate the results. For example, the calculated parameters and correlation values may be reviewed by viewing the calculated parametric data on the computer system. Spots corresponding to the displayed data may also be viewed to ensure the reliability of the results to the satisfaction of the user. The clean image and residual image may also be reviewed to further help the user determine the reliability of the results. Corresponding replicate spots, described below, may be viewed as an additional data reliability check.

One embodiment of the invention involves diffusive contact between a card carrying a chemical array and a gel used in a spot-generating assay. During assay formation, replicate compound dots are placed on the gel. In one embodiment, duplicate compound dots are placed in an array having different adjacent neighbors, according to the teachings of the co-pending application entitled SPOTTING PATTERN FOR PLACEMENT OF COMPOUNDS IN AN ARRAY, application Ser. No. 60/403,729 filed Aug. 13, 2002. The relative position of the second replicate dot is different for every compound tested on the gel. By performing corresponding analysis on the spots formed at the replicate dot locations, the reliability of spot identification can be increased.

At block 1280, the results can be output to a computer file or to a hardcopy report once the user has completed reviewing the data. The results may consist of a list showing which compound dot locations in the assay resulted in hit spot formations in the digital representation, according to one embodiment. The results may also include the calculated parameters for each spot to facilitate further quantitative analysis of the data.

According to another embodiment, the correlation process used in the first step of spot finding could be replaced with a neural network. The main advantage to a neural network is that it can be trained to be an extremely sensitive classifier. In the case of spot finding, a network could be trained to identify spot centers. The network would learn to answer the question, “Is a spot centered at this position?” A suitable neural networks also can have the property of higher noise immunity than traditional correlation comparison methods. The neural network needs to be trained using real images as input, so the accuracy of the network is closely related to the quality of the data used for training. Since there are several methods used to produce gels or to conduct assays on gels, a neural network could be tailored to each of the methods for greater accuracy.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

1. A method of identifying the location of a compound in an assay pattern created in a free-form biological assay, comprising:
providing an image of the assay pattern, wherein the image has pixels that depict a spot;
identifying the center of the spot by analyzing a plurality of pixels in the image;
generating a model of a signal at the location of the spot, wherein the model of the signal is based on the diffusion of a reactive compound in a reagent containing layer;
determining whether the spot is a signal by comparing the spot and the model; and
for a spot identified as a signal, determining the sample compound location on the assay pattern that corresponds to the image location of the center of the spot.

2. The method of claim 1, wherein generating a model of the signal comprises generating a parametric model of the signal.

3. The method of claim 2, wherein generating a parametric model of the signal comprises:
generating a plurality of parameters describing the spot depicted in the image; and
generating a model of the signal using the parameters.

4. The method of claim 3, wherein comparing the spot and the model comprises:
generating a correlation value that provides a measure of fitness between the model and the parameters, and
determining whether the correlation value exceeds a threshold value.

5. The method of claim 3, further comprising regenerating the parameters of the spot and regenerating the correlation value such that the regenerated parameters affect an increase in the regenerated correlation value.

6. The method of claim 1, wherein analyzing a plurality of pixels in the image comprises interactively identifying a candidate signal from a displayed digital image.

7. The method of claim 1, wherein analyzing a plurality of pixels in the image comprises identifying a candidate signal location using automatic image processing.

8. The method of claim 7, wherein the image processing comprises calculating a pixel intensity slope for each pixel in a set of pixels, storing the results of the calculating step, and combining the stored results to identify the location of the signal.

9. A method of identifying the location of a signal in an image of a biological assay, comprising:
providing an image of the assay, wherein the image has a plurality of pixels depicting the signal;
defining a subimage pixel area in the image;
centering the subimage pixel area on a target pixel in the digital image;
calculating a pixel intensity slope for the target pixel, wherein pixels contained within the subimage area are used to calculate the pixel intensity slope of the target pixel;
storing the result of the calculating step;
repeating the centering, calculating, and storing steps for a plurality of target pixels in the digital image; and
combining the stored results to identify the location of the signal.

10. The method of claim 9, further comprising providing a transform image having pixels, wherein target pixels in the digital image each have a corresponding pixel in the transform image, and wherein the stored results are combined in the transform image.

11. The method of claim 9, wherein a threshold value is applied to the combined results, and wherein spot locations are identified by a combined result that exceeds the threshold value.

12. The method of claim 10, wherein calculating the pixel intensity slope comprises:
assigning to a target pixel one or more values representative of the intensity or color of the target pixel;
determining one or more values for neighbor pixels around the target pixel; and
if the value assigned to the target pixel is different from values of the neighbor pixels, determining a direction representative of maximum change or rate of change of the value from the target pixel into the neighbor pixels, and associating a vector with the target pixel indicative of the direction.

13. A method for identifying a hit spot in a free-form biological assay, where the hit spot is the result of an interaction between a sample compound and a reactive agent, comprising:
providing a digital image, wherein the image depicts a plurality of candidate spots which may include a hit spot;
analyzing the image by image processing means to identify a first candidate spot;
generating a spot function parametrically modeling the first candidate spot; and
analyzing the spot function and the first candidate spot to identify a hit spot depicted in the digital image.

14. The method of claim 13, further comprising:
correlating the first candidate spot to a replicate spot depicted in the image;
generating a spot function parametrically modeling the replicate spot; and
wherein analyzing further comprises analyzing the spot function of the replicate spot and the replicate spot to identify the hit spot depicted in the image.

15. The method of claim 13, further comprising generating a spot correlation value, the correlation value providing a measure of fitness between the spot function and the first candidate spot, and wherein analyzing further comprises analyzing the spot correlation value.

16. The method of claim 15, further comprising:
generating candidate spot parameters describing the first candidate spot; and
wherein analyzing further comprises analyzing the first candidate spot parameters.

17. The method of claim 16, wherein parameters comprise radius and amplitude.

18. The method of claim 17, wherein parameters further comprise sigma, base, flatness, and a flatness threshold.

19. The method of claim 14, further comprising:
generating a replicate spot correlation value, the replicate spot correlation value providing a measure of fitness between the replicate spot function and the replicate spot; and
wherein analyzing further comprises analyzing the replicate spot correlation value.

20. The method of claim 19, further comprising:
generating replicate spot parameters describing the replicate spot depicted in the image; and
wherein analyzing further comprises analyzing the replicate spot parameters.

21. A system for identifying a signal location in a digital image of a biological assay, comprising:
a gradient triangulation subsystem with means for identifying the location of a candidate signal in the image; and
a signal modeling subsystem with means for processing a set of pixels in the image proximate to the candidate signal location to determine if a signal exists at the candidate signal location.

22. The system of claim 21, further comprising an alignment subsystem with means for identifying a plurality of alignment spots depicted in the image and matching the alignment spots to a known alignment pattern.

23. The system of claim 21, further comprising a preprocessing subsystem configured to filter noise from the image.

24. A method of identifying a hit spot depicted in an image, comprising:
providing a digital image, wherein the image may depict hit spots;
processing the image by image processing means to acquire a set of spots depicted in the image;
generating parameters for each spot in the set;
generating a spot function for each spot in the set, the spot function parametrically modeling each spot; and
analyzing the spot function and the parameters to identify hit spots from the set of spots depicted in the image.

25. The method of claim 24, further comprising:
generating a correlation value for each spot in the set of spots, the correlation value providing a measure of fitness between the spot function and each spot, and
wherein said analyzing further comprises analyzing the correlation values.

26. The method of claim 25, further comprising:
generating a list of spots having a high correlation value;
for the list of spots:
(a) optimizing the parameters of a selected spot on the list, the selected spot having the highest value;
(b) removing the selected spot from the list of spots;
(c) removing information related to the selected spot from the image;
(d) generating a new correlation value for each spot remaining on the list; and
(e) repeating steps (a)-(d) until there are no remaining spots on the list.

27. A method of correlating a hit spot depicted in an image with a corresponding sample compound location, comprising:
providing a digital image, wherein the digital image depicts one or more alignment spots and may depict hit spots;
identifying one or more alignment spots depicted in the image;
registering the image by matching the one or more alignment spots to a known alignment pattern;
identifying a spot depicted in the image;
generating a spot function, the spot function parametrically modeling the spot;
comparing the spot function and the spot to determine if the spot is a hit spot; and
correlating the location of the hit spot depicted in the image with a known sample compound pattern to identify a sample compound location corresponding to the location of the hit spot.

28. The method of claim 27, wherein matching comprises manually matching.

29. The method of claim 27, wherein matching comprises matching using image processing means.

30. The method of claim 29, wherein the image processing means comprises gradient triangulation.

31. The method of claim 27, wherein registering the image further comprises generating a theta value, wherein theta is an alignment factor for rotational correction.

32. The method of claim 31, wherein registering the image further comprises generating at least one scale, wherein the scale factor is an alignment factor for converting an image measurement to a distance measurement.

33. The method of claim 32, wherein the scale factor is used in computing the conversion from image pixels to millimeters.

34. The method of claim 32, wherein registering the image further comprises computing at least one offset factor, wherein the offset factor is used in computing the true position of an alignment spot.

35. A method of correlating a signal in a representative digital image of a free-form biological assay to an associated sample compound location, comprising:
identifying the location of a candidate signal in the digital image;
generating a function to model a signal formed in a free-form biological assay;
generating a parameter describing the candidate signal;
generating a correlation value, the correlation value being a measure of fitness between the function and the candidate signal;
analyzing the digital image using the correlation value to identify a signal location in the digital image; and
correlating the signal location with a known assay pattern to identify a sample compound location.

36. A computer readable medium tangibly embodying a program of instructions executable by a computer to perform a method of identifying a location in of a sample compound that generated a hit spot in a biological assay, the method comprising:
providing a digital image of the assay, wherein the image comprises pixels depicting a spot;
analyzing the pixels to identify the location of the spot;
generating a parameter describing the spot;
generating a spot function using the parameter, the spot function parametrically modeling the spot;
generating a correlation value, the correlation value being a measure of fitness between the spot function and the spot;
analyzing the correlation value to determine if the spot is a hit spot; and
matching the location of the hit spot in the image with an assay pattern to identify a sample compound location.

37. A method for identifying features of an image, comprising:
providing a digital image comprising pixels;
for a set of pixels in the image:
(a) assigning to a target pixel one or more values representative of one or more of intensity or color of the target pixel;
(b) determining the one or more values for neighbor pixels around the target pixel;
(c) if the value assigned to the target pixel is different from values of the neighbor pixels, determining a direction representative of maximum change or rate of change of the value from the target pixel into the neighbor pixels, and associating a vector with the target pixel indicative of the direction;
(d) repeating steps (a)-(c) for each pixel in the set; and
(e) identifying one or more features by identifying a pattern from said vectors.

38. The method of claim 37, wherein pattern comprises intersection of vectors.

39. The method of claim 37, further comprising graphically representing vectors as symbols in a visual image.

40. The method of claim 37, wherein the symbols represent the direction of the vectors.

41. The method of claim 37, wherein the symbols represent the direction and magnitude the vectors.

42. The method of claim 37, further comprising preparing a data set comprising the vectors generated in steps (a)-(d).

43. The method of claim 42, wherein data set includes coordinates associated with each vector.

44. A method for identifying the location of a spot in an image of a multiplexed assay, comprising:
selecting a first target location in said image;
comparing the color or intensity of the first target location with that of surrounding target locations to ascertain a direction of a maximum color or intensity change through said first target location, referred to herein as an intensity slope vector;
repeating the selecting and comparing steps with other target locations in said image to identify a location in said image where intensity slope vectors converge.

45. The method of claim 44, wherein said target locations are pixels.

46. The method of claim 44, further comprising correlating the location of the spot to the identity or location of a compound dot used in said multiplexed assay.

47. A method of registering a digital image of a biological assay, comprising:
providing a digital image containing pixels, wherein the pixels depicts a plurality of spots;
identifying one or more alignment spots depicted in the image;
matching the one or more alignment spots to a known pattern of alignment spots;
calculating a plurality of alignment factors for a plurality of locations in the image based on said matching; and
registering the image using the alignment factors to match the spot locations to known locations using a sample compound pattern.

48. The method of claim 47, where the alignment factors are calculated for every pixel in the digital image.

49. The method of claim 47, where the alignment factors comprise (x, y) offset.

50. The method of claim 47, where the alignment factors comprise (x,y) scale.

51. The method of claim 47, where the alignment factors comprise theta rotation.

52. A method of registering a digital image to identify a hit spot in an image with a corresponding sample compound location, comprising:
providing a digital image, wherein the digital image depicts a plurality of alignment spots and at least one pair of hit spots;
identifying one or more alignment spots depicted in the image;
registering the image by matching the one or more alignment spots to a known alignment pattern;
identifying a probable pair of hit spots depicted in the image;
calculating a plurality of alignment factors using the locations of the probable pair of hit spots and the alignment spots, and using known patterns of pairs of hit spots and the alignment patterns;
registering the image using the calculated alignment factors to match the locations of the image to known locations in a sample compound pattern; and
determining if an additional probable pair of hit spots is in the image, and if so, iteratively repeating said calculating step and said registering step using the additionally identified pair of hit spots.

53. A method of identifying a hit spot in an image, comprising:
providing a digital image, wherein the image may depict hit spots;
processing the image by image processing means to acquire a set of spots depicted in the image;
generating parameters for each spot in the set;
generating a value for each spot in the set, wherein the value is a measure of whether the spot is a hit spot;
generating a list of spots having a high value;
for the list of spots:
(a) optimizing the parameters of a selected spot on the list, the selected spot having the highest value;
(b) removing the selected spot from the list of spots;
(c) removing information related to the selected spot from the image;
(d) generating a new value for each spot remaining on the list;
(e) repeating steps (a)-(d) until there are no remaining spots on the list; and
analyzing a spot using its value to identify the spot as a hit a spot.

54. The method of claim 53, wherein the value relates to the intensity of the spot depicted in the digital image.

55. The method of claim 53, wherein the value relates to the size of the spot depicted in the digital image.
